(19) United States
(12) Patent Application Publication
(10) Pub. No.: US 2017/0330134 A1
(43) Pub. Date: Nov. 16, 2017

(54) AUTOMATED INTELLIGENT BIN COLLECTION SERVICE USING AUTONOMOUS MOBILE BINS

(71) Applicant: International Business Machines Corporation, Armonk, NY (US)

(72) Inventors: Adi Botea, Dublin (IE); Radu Marinescu, Dublin (IE)

(21) Appl. No.: 15/155,763

(22) Filed: May 16, 2016

(51) Int. Cl. G06Q 10/08; G06Q 10/06; G06Q 10/00

(52) U.S. Cl. CPC G06Q 10/083; G06Q 10/30; G06Q 10/06314; G05D 2201/0216; B64C 2201/128

(57) ABSTRACT

Automatically collecting bin content by receiving input data comprising geographic information, a set of constraints, a first set of status parameters corresponding to each of a plurality of service vehicles, and a second set of status parameters corresponding to each of a plurality of autonomous mobile bins. The input data is used to compute a first set of schedules for each of the plurality of service vehicles and a second set of schedules for each of the plurality of autonomous mobile bins. The first set of schedules and the second set of schedules together specify at least one meeting point at a meeting time between a service vehicle of the plurality of service vehicles and at least one bin of the plurality of autonomous mobile bins.

### FIELD

The present application relates generally to collection and delivery services and, more specifically, to a new and useful system and method for performing bin collection and routing.

### BACKGROUND

The exponential growth in human population, coupled with improved standards of living, has created new challenges in the area of collection and delivery services. Parcel carriers are called upon to expeditiously collect and deliver an ever-increasing number of packages to customers. Fuel delivery trucks must travel through urbanized areas that are becoming increasingly crowded. Likewise, prevailing trends in consumable item packaging have resulted in a significant increase in the amount of waste generation. Accordingly, it has been necessary to develop new technologies which provide for efficient management of collection and delivery services such as parcel collection, fuel delivery, waste removal, and recycling. In order to ensure a sustainable human population, it is important to implement collection and delivery activities in such a manner that they provide a net benefit to the population.

Significant challenges are faced when collection and delivery activities must be performed at a multiplicity of locations scattered throughout an urbanized area. These challenges include scheduling appropriate routes for drivers so that collections are maximized and delays are minimized. For example, in the context of waste management, inadequate planning and scheduling results in a delayed collection of waste. Garbage may overflow from containers, creating potential safety and health hazards. Likewise, a dramatically increased consumption of food and drink products may occur during special events and festivals, overwhelming waste containers and posing difficulties with regard to waste collection. Yet if waste collection intervals are determined based upon periods of peak waste generation, the result is a very inefficient process whereby waste collection trucks are repeatedly deployed to empty waste containers that are only partially filled.

### SUMMARY

The following summary is merely intended to be exemplary. The summary is not intended to limit the scope of the claims.

A method for automatically collecting bin content, in one aspect, may comprise receiving input data comprising geographic information, a set of constraints, a first set of status parameters corresponding to each of a plurality of service vehicles, and a second set of status parameters corresponding to each of a plurality of autonomous mobile bins, wherein the plurality of autonomous mobile bins are each configured for storing physical content comprising one or more of waste, recyclable material, parcels for delivery, parcels for collection, or fuel; using the input data to prepare a first set of schedules for each of the plurality of service vehicles and a second set of schedules for each of the plurality of autonomous mobile bins, wherein the first set of schedules and the second set of schedules together specify at least one meeting point at a meeting time between a service vehicle of the plurality of service vehicles and at least one bin of the plurality of autonomous mobile bins, and wherein the at least one bin is configured for emptying the stored physical content into the service vehicle at the meeting point. Alternatively or additionally, the at least one bin is configured for accepting physical content delivered by the service vehicle at the meeting point.

A computer program product for performing automatic collection of bin content, in another aspect, may comprise a computer-readable storage medium having a computer-readable program stored therein, wherein the computer-readable program, when executed on a computer, causes the computer to receive input data comprising geographic information, a set of constraints, a first set of status parameters corresponding to each of a plurality of service vehicles, and a second set of status parameters corresponding to each of a plurality of autonomous mobile bins, wherein the plurality of autonomous mobile bins are each configured for storing physical content comprising one or more of waste, recyclable material, parcels for delivery, parcels for collection, or fuel; using the input data to prepare a first set of schedules for each of the plurality of service vehicles and a second set of schedules for each of the plurality of autonomous mobile bins, wherein the first set of schedules and the second set of schedules together specify at least one meeting point at a meeting time between a service vehicle of the plurality of service vehicles and at least one bin of the plurality of autonomous mobile bins, and wherein the at least one bin is configured for emptying the stored physical content into the service vehicle at the meeting point. Alternatively or additionally, the at least one bin is configured for accepting physical content delivered by the service vehicle at the meeting point.

An apparatus for performing automatic collection of bin content, in another aspect, may comprise a processor and a memory coupled to the processor, wherein the memory comprises instructions which, when executed by the processor, cause the processor to receive input data comprising geographic information, a set of constraints, a first set of status parameters corresponding to each of a plurality of service vehicles, and a second set of status parameters corresponding to each of a plurality of autonomous mobile bins, wherein the plurality of autonomous mobile bins are each configured for storing physical content comprising one or more of waste, recyclable material, parcels for delivery, parcels for collection, or fuel; using the input data to prepare a first set of schedules for each of the plurality of service vehicles and a second set of schedules for each of the plurality of autonomous mobile bins, wherein the first set of schedules and the second set of schedules together specify at least one meeting point at a meeting time between a service vehicle of the plurality of service vehicles and at least one bin of the plurality of autonomous mobile bins, and wherein the at least one bin is configured for emptying the stored physical content into the service vehicle at the meeting point. Alternatively or additionally, the at least one bin is configured for accepting physical content delivered by the service vehicle at the meeting point.

### BRIEF DESCRIPTION OF THE SEVERAL VIEWS OF THE DRAWINGS

The foregoing aspects and other features are explained in the following description, taken in connection with the accompanying drawings, wherein:

FIG. 1 is a flowchart illustrating a first exemplary method for performing automatic collection of bin content.

FIG. 2 is a flowchart illustrating an exemplary initialization procedure for performing an initial computation of a schedule for automatically collecting bin content.

FIG. 3 is a flowchart illustrating an exemplary monitoring procedure for monitoring automatic collection of bin content.

FIGS. 4A and 4B together comprise a flowchart illustrating an exemplary replanning procedure for replanning a schedule for automatically collecting bin content.

FIG. 5 is a flowchart illustrating an exemplary procedure for replanning in response to a service vehicle failure.

FIG. 6 is a schematic of an exemplary computer or processing system that may implement any of the methods of FIGS. 1-5.

FIG. 7 is a hardware block diagram of an illustrative autonomous mobile bin for use with any of the methods described in FIGS. 1-6.

FIG. 8 is a hardware block diagram of an illustrative service vehicle for use with any of the methods described in FIGS. 1-6.

### DETAILED DESCRIPTION

The present disclosure relates to improved systems and methods for performing bin collection and routing. According to an embodiment disclosed herein, a geographic area is equipped with a respective plurality of bins at a corresponding plurality of locations. These bins are autonomous and mobile, such that they can be moved and controlled from a remote location over a wireless communications link.

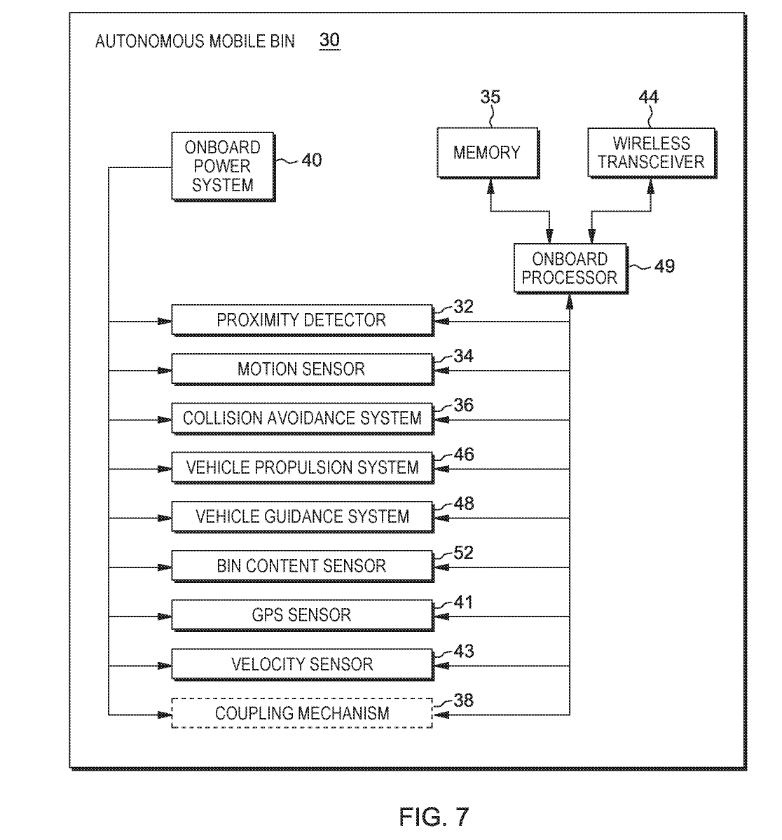

With reference to FIG. 7, an autonomous mobile bin 30 may be provided in the form of a self-propelled vehicle. The bin 30 is configured for storing physical content such as waste, recyclable material, parcels for delivery, parcels for collection, fuel, or any of various combinations thereof. The bin 30 is equipped with safety features, including one or more of a proximity detector 32, a motion sensor 34, or a collision avoidance system 36. Illustratively, a camera may be used to implement the proximity detector 32 and/or the motion sensor 34. An onboard power system 40 provides a power source for a vehicle propulsion mechanism 46, a vehicle guidance system 48, and an onboard processor 49. The onboard power system 40 may be identical or similar to that used on electric-powered bicycles.

The onboard processor 49 is operatively coupled to a computer-readable memory 35. A bin content sensor 52 provides an indication of a remaining content storage capacity or an existing content level for the bin 30. A Global Positioning System (GPS) sensor 41 determines a real-time geographic location for the bin 30. A velocity sensor 43 determines a current speed for the bin 30. A wireless transceiver 44 receives commands and requests for the vehicle guidance system 48, and transmits status parameters gathered by the vehicle guidance system and the bin content sensor 52. These status parameters may comprise any of a full/non-full status for the bin 30, an indication of remaining content storage capacity for the bin 30, an existing content level for the bin 30, a current geographic location for the bin 30, or a current speed for the bin 30.

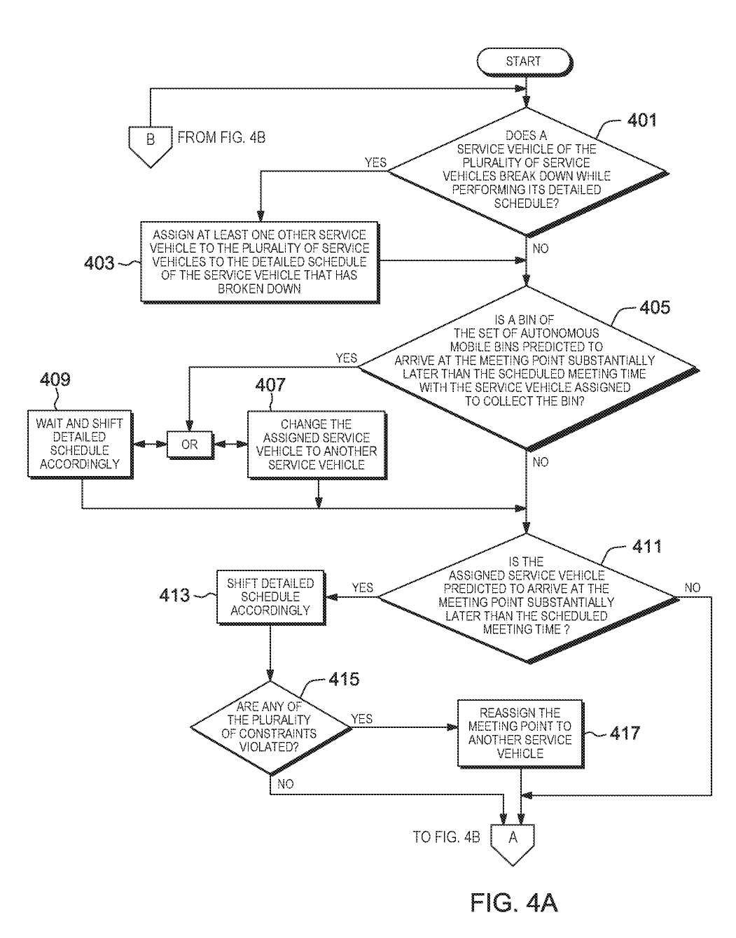

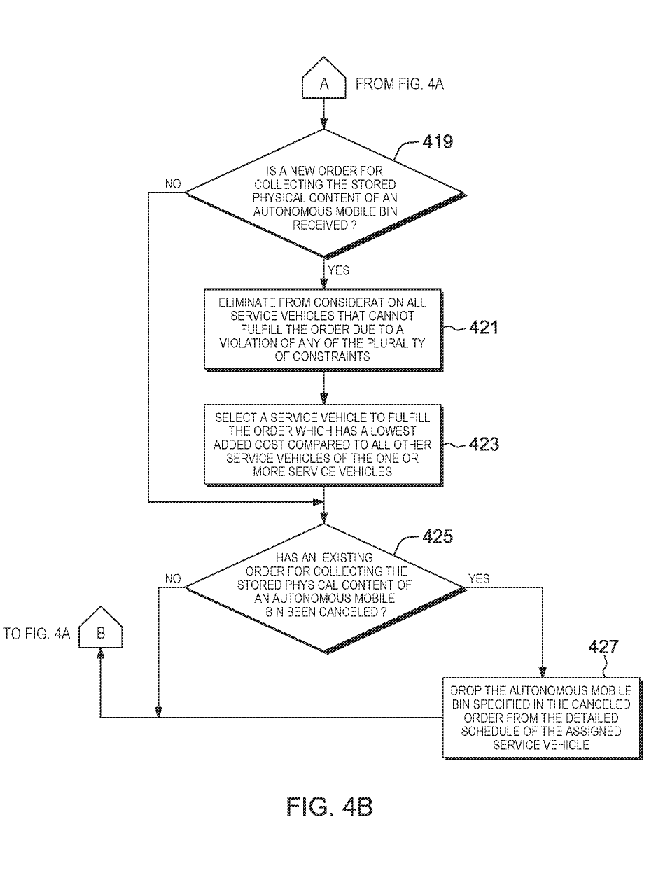

For purposes of illustration, the bin 30 can be approximately 1 to 15 feet long, 1 to 8 feet wide, and 1 to 5 feet tall, moving at speeds ranging from 0.1 mph to 11 mph, and supporting physical content ranging in weight from a few ounces to 1000 pounds. In one set of embodiments, the speed of the bin 30 may be limited to a walking speed, and the bin 30 may be programmed to stop when the proximity detector 32 or motion sensor 34 detects an obstacle ahead. The bin 30 may be configured or programmed to cooperate with other bins to avoid collisions, congestion, and deadlock situations with the scheduled routes of these bins. If the bin 30 executes a collision, congestion, or deadlock-avoiding maneuver, it may be necessary to trigger the replanning procedure of FIGS. 4A-4B (described in greater detail hereinafter).

The bin 30 may be configured or programmed for automated travel between a driveway of a private residence and the entrance of a subdivision in which the residence is located. This automated travel may be controlled from a remote control location by sending GPS data gathered by the GPS sensor 41 over the wireless transceiver 44 to the remote control location, or controlled locally by storing a program in the memory 35. The remote control location issues commands which are received by the wireless transceiver and inputted to the vehicle guidance system 48. Optionally, the bin 30 may include a coupling mechanism 38 for grouping a plurality of bins into a train formation.

A fleet of service vehicles are provided. All, some, or none of these vehicles may be driverless. The service vehicles are deployed to collect contents from a plurality of bins, including the bin 30, and to move the collected contents to one or more collection sites, such as parcel delivery services, landfills or recycling plants.

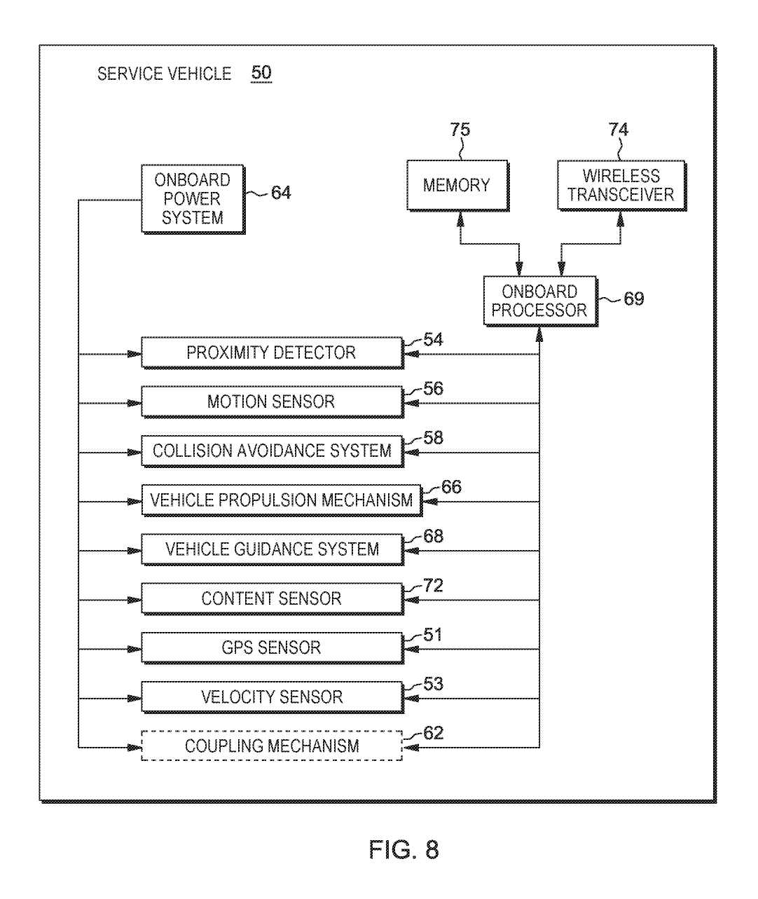

FIG. 8 is a hardware block diagram of an exemplary service vehicle 50. For purposes of illustration, the service vehicle 50 is autonomous, mobile, self-propelled, and driverless, such that it can be moved and controlled from a remote location over a wireless communications link. Alternatively or additionally, the service vehicle 50 may represent a truck that is driven by an on-board driver. The service vehicle 50 is configured for storing content collected from a plurality of bins. A content sensor 72 provides an indication of a remaining content storage capacity or an existing content level for the service vehicle 50. A Global Positioning System (GPS) sensor 51 determines a real-time geographic location for the service vehicle 50. A velocity sensor 53 determines a current speed for the service vehicle 50. A wireless transceiver 74 receives commands and requests for the service vehicle 50, and transmits status parameters gathered by the GPS sensor 51 and the content sensor 72. These status parameters may specify any of a full/non-full status for the service vehicle 50, an indication of remaining content storage capacity for the service vehicle 50, an existing content level for the service vehicle 50, a current geographic location for the service vehicle 50, or a current speed for the service vehicle 50.

If the service vehicle 50 is driverless, it may be equipped with safety features including one or more of a proximity detector 54, a motion sensor 56, or a collision avoidance system 58. An onboard power system 64 provides a power source for a vehicle propulsion mechanism 66, a vehicle guidance system 68, and an onboard processor 69. The onboard processor 69 is operatively coupled to a computer-readable memory 75. The wireless transceiver 74 receives commands and requests for the vehicle guidance system 68, and transmits status information gathered by the vehicle guidance system 68. Optionally, the service vehicle 50 may include a coupling mechanism 62 for grouping a plurality of vehicles into a train formation.

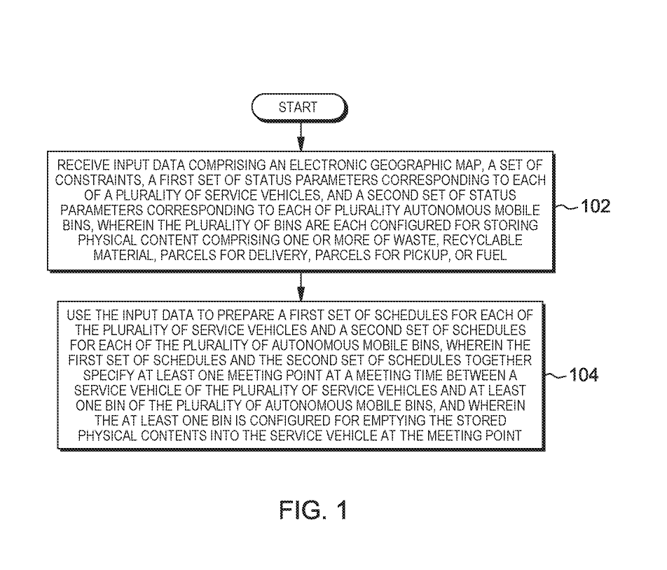

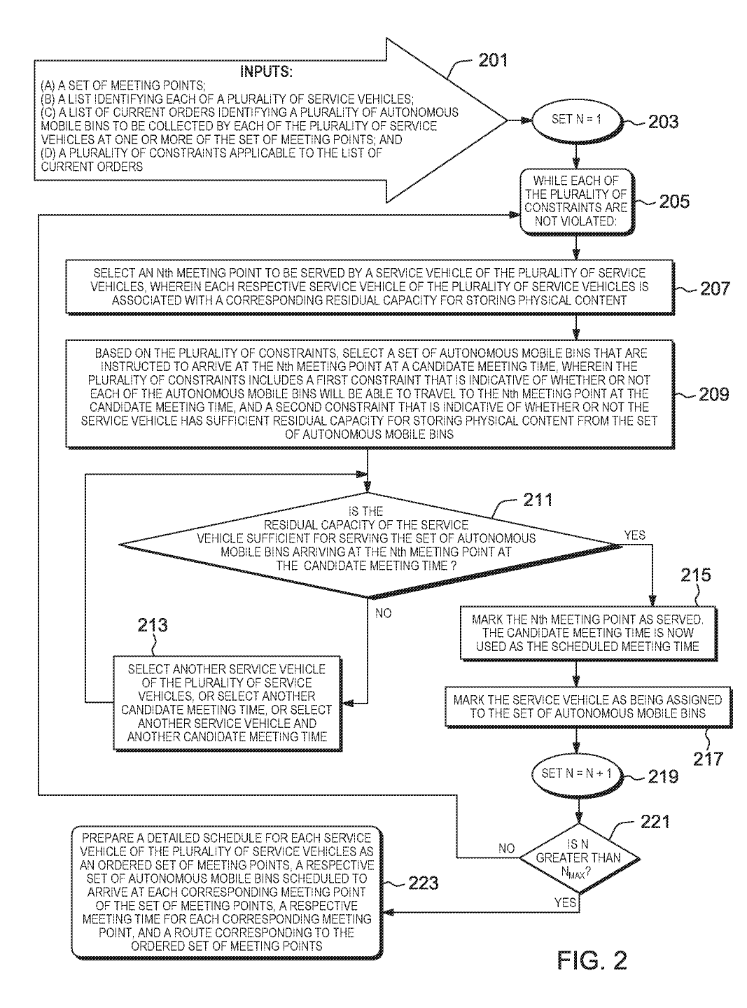

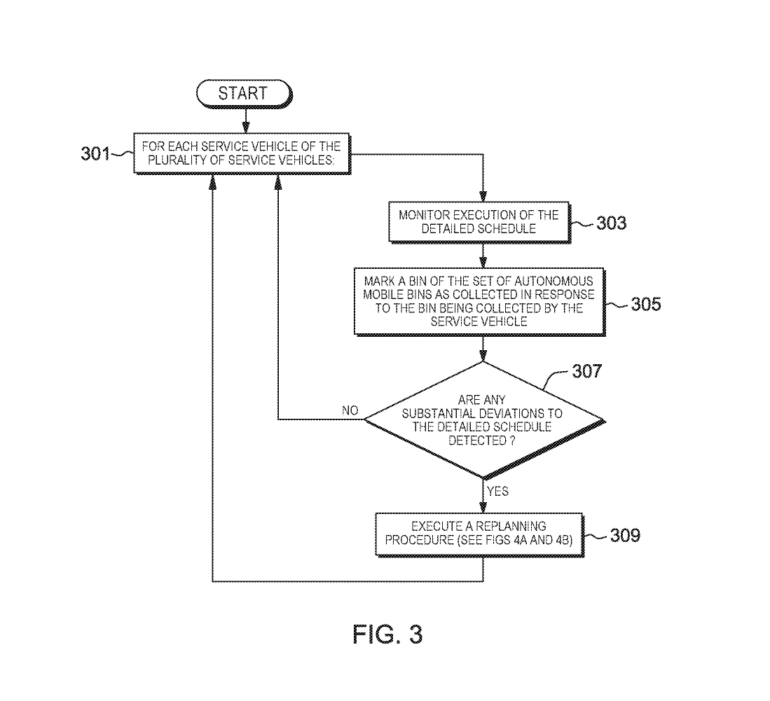

Illustratively, the procedures of FIGS. 1 and 2 are regarded as a main set of processes that are executed at the beginning of a collection or delivery period, or that are executed following the end of a previous collection or delivery period. By comparison, the procedures of FIGS. 3, 4A-4B, and 5 (to be described hereinafter) are performed dynamically and repeatedly throughout the collection and delivery period. A collection and delivery period may be defined as a 24-hour day, a business workday, a week, a month, or another period of time.

FIG. 1 is a flowchart illustrating a first exemplary method for performing automatic collection of bin content. The method commences at block 102 where input data is received. The input data comprises geographic information, a set of constraints, a first set of status parameters corresponding to each of a plurality of service vehicles (such as the service vehicle 50 of FIG. 8), and a second set of status parameters corresponding to each of a plurality of autonomous mobile bins (such as the bin 30 of FIG. 7). Each of the plurality of autonomous mobile bins is configured for storing physical content such as waste material, recyclable material, parcels for collection, parcels for delivery, fuel, or any of various combinations thereof. The geographic information may comprise an electronic map.

For purposes of illustration, the first set of status parameters may comprise any of a full/non-full physical content status for the service vehicle 50 (FIG. 8), an indication of remaining content storage capacity for the service vehicle 50, an existing content level for the service vehicle 50, a current geographic location for the service vehicle 50, or a current speed for the service vehicle 50. The second set of status parameters may comprise any of a full/non-full physical content status for the bin 30 (FIG. 7), an indication of remaining content storage capacity for the bin 30, an existing content level for the bin 30, a current geographic location for the bin 30, or a current speed for the bin 30.

Illustratively, the set of constraints may include one or more of the following: (A) the bin 30 may only be collected during a specific time window (for example, 5:00 AM to 9:00 AM); (B) the bin 30 cannot remain uncollected for more than 12 hours; (C) the content storage capacity of the service vehicle 50 (FIG. 8) cannot be exceeded; or (D) a first service vehicle that is at a first distance from the bin 30 (FIG. 7) is preferred to a second service vehicle that is at a second distance from the bin 30, wherein the first distance is less than the second distance.

The operational sequence of FIG. 1 progresses to block 104 where the input data is used to prepare a first set of schedules for each of the plurality of service vehicles and a second set of schedules for each of the plurality of autonomous mobile bins. The first set of schedules and the second set of schedules together specify at least one meeting point at a meeting time between a service vehicle of the plurality of service vehicles and at least one bin of the plurality of autonomous mobile bins. The at least one bin is configured for emptying the stored physical content into the service vehicle at the meeting point. Alternatively or additionally, the at least one bin is configured for accepting physical content delivered by the service vehicle at the meeting point. In one set of embodiments, the meeting point is determined automatically. In other sets of embodiments, the meeting point is received from a logistics expert.

The first and second sets of schedules may be computed by optimizing an objective function of resource consumption. The optimization may be performed periodically, repeatedly, continuously, or “on-the-fly”. An “on-the-fly” implementation may be performed in real time, in response to a change in conditions. These conditions include, but are not limited to, weather conditions, traffic conditions, or service vehicle breakdowns. The resources may include a total amount of fuel consumed by the plurality of service vehicles, a total amount of time needed to collect bin content, and a total number of service vehicles used to collect the bin content. Alternatively or additionally, the objective function may be formulated to maximize a number or quantity of bins that are served by the service vehicles during a specified duration of time. The objective function may be optimized and updated dynamically in response to changes in any of weather conditions, traffic conditions, or service vehicle breakdowns. Optimizing the objective function may result in quieter neighborhoods, increased efficiencies in terms of time and fuel, and a cleaner environment.

FIG. 2 is a flowchart illustrating an exemplary initialization procedure for performing an initial computation of a schedule for automatically collecting bin content. The procedure commences at block 201 where a plurality of inputs are accepted, including a set of N meeting points (N being a positive integer), a list identifying each of a plurality of service vehicles (such as the service vehicle 50 of FIG. 8), a list of current orders identifying a plurality of autonomous mobile bins (illustratively including the bin 30 of FIG. 7) that are to be collected by each of the plurality of service vehicles at one or more of the set of meeting points, and a plurality of constraints applicable to the list of current orders. The plurality of constraints includes a first constraint that is indicative of whether or not each of the autonomous mobile bins will be able to travel to an Nth meeting point at the candidate meeting time, and a second constraint that is indicative of whether or not the service vehicle has sufficient residual capacity for storing physical content from the set of autonomous mobile bins.

The operational sequence of FIG. 2 progresses to block 203 where N is set to 1. N is an integer value representing a number or quantity of meeting points. Next, block 205, a while loop is commenced. This while loop is a control flow statement that allows the procedures of blocks 207 to 223 to be executed repeatedly, as long as the plurality of constraints remain satisfied. The while loop of block 205 may be conceptualized as a repeating “if” statement. If the plurality of constraints are satisfied (block 205), the program advances to block 207 where an Nth meeting point is selected to be served by a service vehicle of the plurality of service vehicles. Each respective service vehicle of the plurality of service vehicles is associated with a corresponding residual capacity for storing physical content such as waste material, recyclable material, parcels for delivery, parcels for collection, fuel, or any of various combinations thereof.

Based on the plurality of constraints, a set of autonomous mobile bins is selected and instructed to arrive at the Nth meeting point at a candidate meeting time (block 209). As previously mentioned, the plurality of constraints includes a first constraint that is indicative of whether or not each of the autonomous mobile bins will be able to travel to the Nth meeting point at the candidate meeting time, and a second constraint that is indicative of whether or not the service vehicle has sufficient residual capacity for storing content from the set of autonomous mobile bins. Next, at block 211, a test is performed to ascertain whether or not the residual capacity of the service vehicle is sufficient for serving the set of autonomous mobile bins arriving at the Nth meeting point at the candidate meeting time. If not, the program advances to block 213 where another service vehicle of the plurality of service vehicles is selected, or another candidate meeting time is selected, or another service vehicle and candidate meeting time are selected, and the program then loops back to block 211.

The affirmative branch from block 211 leads to block 215 where the Nth meeting point is marked as served, and the candidate meeting time is now used as the scheduled meeting time. The service vehicle is marked as being assigned to the set of autonomous mobile bins (block 217). N is then set to N+1 (block 219). A test is performed at block 221 to ascertain whether or not N is greater than N_{MAX}, where N_{MAX} is an integer value that represents a maximum number or quantity of meeting points. If not, the program loops back to block 203 to determine whether or not any of the plurality of constraints have been violated and, if not, the program then advances to block 205.

The affirmative branch from block 221 leads to block 223 where a detailed schedule is prepared for each service vehicle of the plurality of service vehicles as an ordered set of meeting points. The schedule also includes a respective set of autonomous mobile bins scheduled to arrive at each corresponding meeting point of the set of meeting points, a respective meeting time for each corresponding meeting point, and a geographic route corresponding to the ordered set of meeting points. Illustratively, the detailed schedule specifies a geographic route together with timing. The detailed schedule may comprise a sequence of segments with implicit or explicit assignments of bins to service vehicles. An example of a schedule may include: Leave a first location L1 at a time M1, follow a trajectory Z1, and reach a second location L2 at a time M2. Schedules are computed for each of the plurality of service vehicles (such as service vehicle 50 of FIG. 8), and each of the plurality of autonomous mobile bins (such as bin 30 of FIG. 7).

FIG. 3 is a flowchart illustrating an exemplary monitoring procedure for monitoring automatic collection of bin content. For each service vehicle of the plurality of service vehicles (block 301), the procedures of blocks 303-309 are performed. At block 303, execution of the detailed schedule is monitored. This detailed schedule was prepared at block 223 of FIG. 2. Next, at block 305 of FIG. 3, a bin of the set of autonomous mobile bins is marked as collected in response to the bin 30 (FIG. 7) being collected by the service vehicle 50 (FIG. 8). A test is performed at block 307 of FIG. 3 to ascertain whether or not any substantial deviations have been detected to the detailed schedule. Examples of substantial deviations include traffic delays, inclement weather, detours, and vehicular breakdowns. If no substantial deviations have been detected, the program loops back to block 301. The affirmative branch from block 307 leads to block 309 where a replanning procedure is executed.

FIGS. 4A and 4B together comprise a flowchart illustrating an exemplary replanning procedure for replanning a schedule for automatically collecting bin content. As previously mentioned, the procedures of FIGS. 1 and 2 are regarded as a main set of procedures to be executed at the beginning of a collection or delivery period, or that are executed following the end of a previous collection or delivery period. By comparison, the procedure of FIGS. 4A-4B is performed dynamically and repeatedly throughout the collection and delivery period.

The procedure of FIGS. 4A and 4B commences at block 401 (FIG. 4A) where a test is performed to ascertain whether or not a service vehicle of the plurality of service vehicles has broken down while performing its detailed schedule. If so, then at least one other service vehicle of the plurality of service vehicles is assigned to the detailed schedule of the service vehicle that has broken down (block 403). The negative branch from block 401 leads to block 405 where a test is performed to ascertain whether or not a bin of the set of autonomous mobile bins is predicted to arrive at the meeting point substantially later than the scheduled meeting time with the service vehicle assigned to collect the bin. A specific length of time associated with “substantially later” is defined in accordance with the application at hand. For example, a greater delay may be tolerable for routine delivery of a parcel, whereas an express delivery may be considered as “substantially later” if the delivery is delayed by more than thirty minutes to an hour.

The affirmative branch from block 405 leads to block 407 or block 409. At block 407, the assigned service vehicle is changed to another service vehicle, and the program advances to block 411. At block 409, the assigned service vehicle is instructed to wait, the detailed schedule is shifted accordingly, and the program advances to block 411. The negative branch from block 405 leads to block 411.

At block 411, a test is performed to ascertain whether or not the assigned service vehicle is predicted to arrive at the meeting point substantially later than the scheduled meeting time. If so, the detailed schedule is shifted accordingly (block 413), and a test is performed at block 415 to ascertain whether or not any of the plurality of constraints are violated. If so, the meeting point is reassigned to another service vehicle (block 417), and the program advances to block 419 (FIG. 4B). The negative branch from block 411 (FIG. 4A) leads to block 419 (FIG. 4B), and the negative branch from block 415 (FIG. 4A) also leads to block 419 (FIG. 4B).

At block 419, a test is performed to ascertain whether or not a new order for collecting the stored physical content of an autonomous mobile bin is received. If so, the program advances to block 421 where all service vehicles that cannot fulfill the order due to a violation of any of the plurality of constraints are eliminated from consideration. Next, at block 423, a service vehicle is selected to fulfill the order which has a lowest added cost compared to all other service vehicles of the one or more service vehicles. The lowest cost may be determined with reference to fuel consumption, distance, travel time, additional delay caused by the new order, or any of various combinations thereof. The program then advances to block 425. The negative branch from block 419 also leads to block 425.

At block 425, a test is performed to ascertain whether or not an existing order for collecting the stored physical content of an autonomous mobile bin has been cancelled. If so, the program advances to block 427 where the autonomous mobile bin specified in the cancelled order is dropped from the detailed schedule of the assigned service vehicle. The program then loops back to block 401 (FIG. 4A). The negative branch from block 425 (FIG. 4B) leads back to block 401 (FIG. 4A).

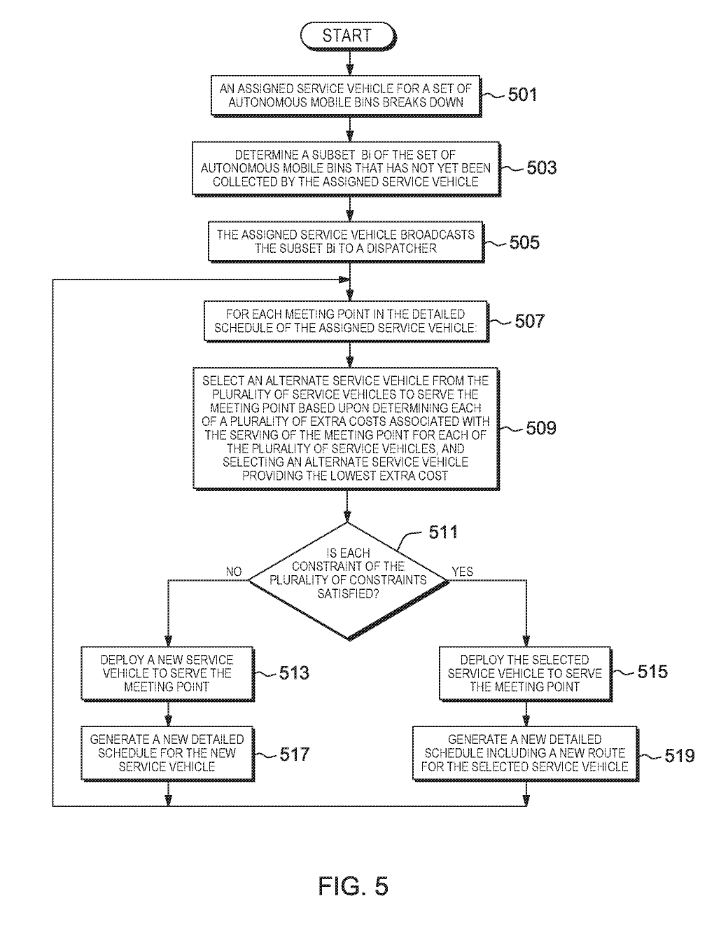

FIG. 5 is a flowchart illustrating an exemplary procedure for replanning in response to a service vehicle failure. The procedure commences at block 501 where an assigned service vehicle 50 (FIG. 8) for a set of autonomous mobile bins (illustratively including bin 30 of FIG. 7) breaks down. Next, at block 503 (FIG. 5), a subset Bi of the set of autonomous mobile bins that has not yet been collected by the service vehicle 50 (FIG. 8) is determined. At block 505 (FIG. 5), the assigned service vehicle 50 (FIG. 8) broadcasts the subset Bi to a dispatcher.

The procedure of FIG. 5 advances to block 507 where, for each meeting point in the detailed schedule of the assigned service vehicle 50 (FIG. 8), the operations of blocks 509-517 (FIG. 5) are performed. At block 509, an alternate service vehicle is selected from the plurality of service vehicles to serve the meeting point based upon determining each of a plurality of extra costs associated with the serving of the meeting point by each of the plurality of service vehicles, and selecting an alternate service vehicle providing the lowest extra cost. Next, at block 511, a test is performed to ascertain whether or not each constraint of the plurality of constraints is satisfied. If so, the program advances to block 515 where the selected service vehicle that was selected at block 509 is deployed to serve the meeting point. A new detailed schedule is generated that includes a new route for the selected service vehicle (block 519), and the program loops back to block 507.

The negative branch from block 511 leads to block 513 where a new service vehicle is deployed to serve the meeting point. This new service vehicle may, for example, represent a service vehicle for which a detailed schedule has not yet been prepared. Next, at block 517, a new schedule is generated for the new service vehicle. The program then loops back to block 507.

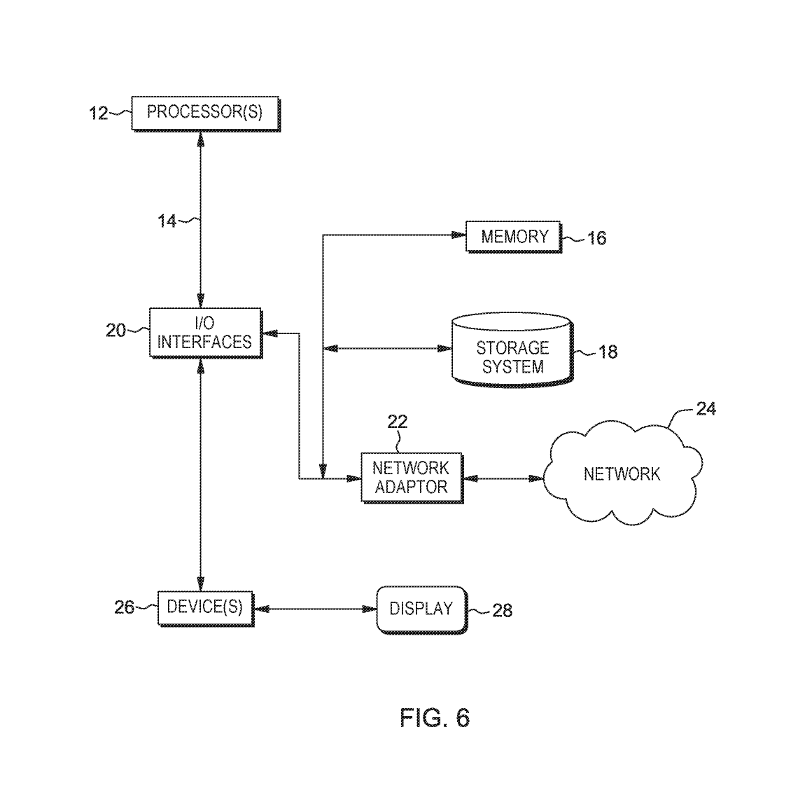

FIG. 6 illustrates a schematic of an exemplary computer or processing system that may implement any of the methods of FIGS. 1-5, in one set of embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of the computer system may include, but are not limited to, one or more processors or processing units 12, a system memory 16, and a bus 14 that couples various system components including system memory 16 to processor 12. The processor 12 may include a module that performs the methods described herein. The module may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. The computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/0) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically collecting bin content, the method comprising:
receiving input data comprising geographic information, a set of constraints, a first set of status parameters corresponding to each of a plurality of service vehicles, and a second set of status parameters corresponding to each of a plurality of autonomous mobile bins; and
using the input data to compute a first set of schedules for each of the plurality of service vehicles and a second set of schedules for each of the plurality of autonomous mobile bins;
wherein the first set of schedules and the second set of schedules together specify at least one meeting point at a meeting time between a service vehicle of the plurality of service vehicles and at least one bin of the plurality of autonomous mobile bins.

2. The method of claim 1 further comprising configuring each of the plurality of autonomous mobile bins for storing a physical content comprising one or more of waste, recyclable material, parcels for delivery, parcels for collection, or fuel.

3. The method of claim 1 further comprising configuring each of the plurality of autonomous mobile bins for one or both of:
accepting a physical content delivered by the service vehicle at the meeting point; or emptying a physical content stored by the at least one bin into the service vehicle at the meeting point.

4. The method of claim 1 wherein the first set of status parameters comprise any of a full/non-full physical content status for the service vehicle, an indication of remaining content storage capacity for the service vehicle, an existing content level for the service vehicle, a current geographic location for the service vehicle, or a current speed for the service vehicle; and
wherein the second set of status parameters comprise any of a full/non-full physical content status for the at least one bin, an indication of remaining content storage capacity for the at least one bin, an existing content level for the at least one bin, a current geographic location for the at least one bin, or a current speed for the at least one bin.

5. The method of claim 1 wherein the set of constraints includes one or more of:
the at least one bin may only be collected during a specific time window;
the at least one bin cannot remain uncollected for more than a specified amount of time;
the content storage capacity of the service vehicle cannot be exceeded; or
a first service vehicle that is at a first distance from a bin of the at least one bin is preferred to a second service vehicle that is at a second distance from the bin, wherein the first distance is less than the second distance.

6. The method of claim 4 further comprising preparing the first and second sets of schedules by optimizing an objective function of resource consumption, wherein the optimization is performed substantially in real time, in response to one or more of:
a change in condition comprising at least one of weather conditions, traffic conditions, or service vehicle breakdowns;
a change in the first set of status parameters; or
a change in the second set of status parameters.

7. The method of claim 6 wherein the resource consumption includes a total amount of fuel consumed by the plurality of service vehicles, a total amount of time needed to collect a physical content from the at least one bin, and a total number of service vehicles used to collect the physical content.

8. The method of claim 6 further comprising formulating the objective function to maximize a number or quantity of bins that are served by the service vehicles during a specified duration of time.

9. An apparatus for automatically collecting bin content, the apparatus comprising a processor and a memory coupled to the processor, wherein the memory comprises instructions which, when executed by the processor, cause the processor to perform:
receiving input data comprising geographic information, a set of constraints, a first set of status parameters corresponding to each of a plurality of service vehicles, and a second set of status parameters corresponding to each of a plurality of autonomous mobile bins; and
using the input data to compute a first set of schedules for each of the plurality of service vehicles and a second set of schedules for each of the plurality of autonomous mobile bins;
wherein the first set of schedules and the second set of schedules together specify at least one meeting point at a meeting time between a service vehicle of the plurality of service vehicles and at least one bin of the plurality of autonomous mobile bins.

10. The apparatus of claim 9 wherein each of the plurality of autonomous mobile bins is configured for storing a physical content comprising one or more of waste, recyclable material, parcels for delivery, parcels for collection, or fuel.

11. The apparatus of claim 9 further comprising configuring each of the plurality of autonomous mobile bins for one or both of:
accepting a physical content delivered by the service vehicle at the meeting point; or
emptying a physical content stored by the at least one bin into the service vehicle at the meeting point.

12. The apparatus of claim 9 wherein the first set of status parameters comprise any of a full/non-full physical content status for the service vehicle, an indication of remaining content storage capacity for the service vehicle, an existing content level for the service vehicle, a current geographic location for the service vehicle, or a current speed for the service vehicle; and
wherein the second set of status parameters comprise any of a full/non-full physical content status for the at least one bin, an indication of remaining content storage capacity for the at least one bin, an existing content level for the at least one bin, a current geographic location for the at least one bin, or a current speed for the at least one bin.

13. The apparatus of claim 9 wherein the set of constraints includes one or more of:
the at least one bin may only be collected during a specific time window;
the at least one bin cannot remain uncollected for more than a specified amount of time;
the content storage capacity of the service vehicle cannot be exceeded; or
a first service vehicle that is at a first distance from a bin of the at least one bin is preferred to a second service vehicle that is at a second distance from the bin, wherein the first distance is less than the second distance.

14. The apparatus of claim 9 further comprising instructions for preparing the first and second sets of schedules by optimizing an objective function of resource consumption, wherein the optimization is performed substantially in real time, in response to one or more of:
a change in condition comprising at least one of weather conditions, traffic conditions, or service vehicle breakdowns;
a change in the first set of status parameters; or
a change in the second set of status parameters.

15. The apparatus of claim 14 wherein the resource consumption includes a total amount of fuel consumed by the plurality of service vehicles, a total amount of time needed to collect a physical content from the at least one bin, and a total number of service vehicles used to collect the physical content.

16. The apparatus of claim 14 further comprising formulating the objective function to maximize a number or quantity of bins that are served by the service vehicles during a specified duration of time.

17. A computer program product for automatically collecting bin content, the computer program product comprising a computer-readable storage medium having a computer-readable program stored therein, wherein the computer-readable program, when executed on a computer, causes the computer to perform:
receiving input data comprising geographic information, a set of constraints, a first set of status parameters corresponding to each of a plurality of service vehicles, and a second set of status parameters corresponding to each of a plurality of autonomous mobile bins; and
using the input data to compute a first set of schedules for each of the plurality of service vehicles and a second set of schedules for each of the plurality of autonomous mobile bins;
wherein the first set of schedules and the second set of schedules together specify at least one meeting point at a meeting time between a service vehicle of the plurality of service vehicles and at least one bin of the plurality of autonomous mobile bins.

18. The computer program product of claim 17 wherein the first set of status parameters comprise any of a full/non-full physical content status for the service vehicle, an indication of remaining content storage capacity for the service vehicle, an existing content level for the service vehicle, a current geographic location for the service vehicle, or a current speed for the service vehicle; and
wherein the second set of status parameters comprise any of a full/non-full physical content status for the at least one bin, an indication of remaining content storage capacity for the at least one bin, an existing content level for the at least one bin, a current geographic location for the at least one bin, or a current speed for the at least one bin.

19. The computer program product of claim 18 further comprising instructions for preparing the first and second sets of schedules by optimizing an objective function of resource consumption, wherein the optimization is performed substantially in real time, in response to one or more of:
a change in condition comprising at least one of weather conditions, traffic conditions, or service vehicle breakdowns;
a change in the first set of status parameters; or
a change in the second set of status parameters.

20. The computer program product of claim 19 wherein the resource consumption includes a total amount of fuel consumed by the plurality of service vehicles, a total amount of time needed to collect a physical content from the at least one bin, and a total number of service vehicles used to collect the physical content.
